(19) United States
(12) Patent Application Publication
(10) Pub. No.: US 2007/0114699 A1
(43) Pub. Date: May 24, 2007

(54) MOLD AND MOLD RELEASING METHOD OF THE SAME

(75) Inventor: Jen-Tsorng Chang, Tu-Cheng,Taipei (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei (TW)

(21) Appl. No.: 11/458,079

(22) Filed: Jul. 17, 2006

(30) Foreign Application Priority Data
Nov. 18, 2005 (TW) 94140610

(51) Int. Cl. B28B 7/12

(52) U.S. Cl. 264/335; 425/437

(57) ABSTRACT

An exemplary mold for molding optical elements includes a mold core and a gas blowing device. The mold core includes a molding surface, at least one gas inlet, a plurality of gas outlets located around the molding surface, a plurality of gas channels defined therein for connecting the at least one gas inlet and the gas outlets, and a plurality of switch elements configured around the molding surface to open and close the gas outlets. The gas blowing device has an output end communicated with the at least one gas inlet configured for blowing gas into the gas channels. A mold releasing method using the mold is also provided.

### FIELD OF THE INVENTION

The present invention relates to a mold and a mold releasing method of the same, and more particularly relates to a mold being suitable for molding optical elements and a mold releasing method using the same.

### DESCRIPTION OF RELATED ART

Optical elements are generally made by molding processes. Especially for plastic optical elements, such as micro lenses or light guide plates, the injection molding method is generally employed. The injection molding method has advantages such as high production rate and efficiency, and cost of optical elements thereby can be reduced. During the molding process, ejector elements are generally employed for separating the optical elements from a molding surface of the mold.

In a typical mold for molding optical elements, ejector pins are employed as the ejector elements. In operation, the ejector pins can push peripheries of the optical elements to separate the optical elements from molding surfaces. However, optical elements are required to satisfy requirements such as downsizing and weight reduction, and the peripheral portions of the optical elements are getting smaller. Correspondingly, the diameters of the ejector pins must be downsized, which results that the ejector pins are too small to separate the optical elements easily.

In another typical mold for molding optical elements, a mold core is employed as the ejector element. However, the movements of the mold core may lead to problems such as abrasion and decentration, which results that the quality of the optical elements is reduced, and the service life of the mold is shorten.

What is needed, therefore, is a mold for molding optical elements which has long service life and can release optical elements easily.

What is also needed, therefore, is a mold releasing method using the mold.

### SUMMARY OF THE INVENTION

In a preferred embodiment, a mold for molding optical elements includes a mold core and a gas blowing device. The mold core includes a molding surface, at least one gas inlet, a plurality of gas outlets located around the molding surface, a plurality of gas channels defined therein for connecting the at least one gas inlet and the gas outlets, and a plurality of switch elements positioned around the molding surface and configured for opening and closing the gas outlets. The gas blowing device has an output end communicated with the at least one gas inlet and is configured for blowing gas into the gas channels.

In another preferred embodiment, a mold releasing method using the above-described mold comprises the steps of: opening the gas outlets by operating the switch elements; blowing gas into the gas channels via the output end and the at least one gas inlet by operating the gas blowing device; and releasing the optical element by adjusting the pressure of the gas via controlling the output end.

Other advantages and novel features will become more apparent from the following detailed description when taken in conjunction with the accompanying drawings, in which:

### BRIEF DESCRIPTION OF THE DRAWINGS

Many aspects of the present invention can be better understood with reference to the following drawings. The components in the drawings are not necessarily to scale, the emphasis instead being placed upon clearly illustrating the principles of the present invention. Moreover, in the drawings, like reference numerals designate corresponding parts throughout the several views.

FIG. 1 is a schematic, cross-sectional view of a mold for molding optical elements in accordance with a first preferred embodiment;

FIG. 2 illustrates a schematic, cross-sectional view of the mold of FIG. 1 during molding process;

FIG. 3 illustrates a schematic, cross-sectional view of the mold of FIG. 1 during mold releasing process;

FIG. 4 is a schematic, cross-sectional view of a mold for molding optical elements in accordance with a second preferred embodiment during molding process; and

FIG. 5 illustrates a schematic, cross-sectional view of the mold of FIG. 4 during mold releasing process.

The exemplifications set out herein illustrate at least one preferred embodiment of the invention, in one form, and such exemplifications are not to be construed as limiting the scope of the invention in any manner.

### DETAILED DESCRIPTION OF THE INVENTION

Embodiments of the present invention will now be described in detail below and with reference to the drawings.

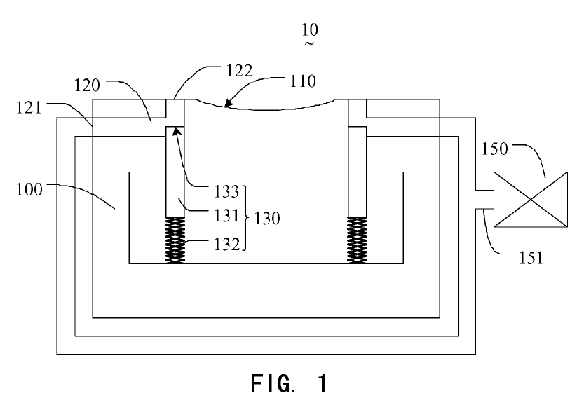

Referring to FIG. 1, a mold 10 according to a first preferred embodiment is provided. The mold 10 includes a mold core 100 and a gas blowing device 150. The mold core 100 includes a molding surface 110, a plurality of gas inlets 121, a plurality of gas outlets 122 located around the molding surface 110, a plurality of gas channels 120 connecting the gas inlets 121 and the gas outlets 122, and a plurality of switch elements 130 positioned around the molding surface 110 and configured for opening and closing the gas outlets 122. The gas blowing device 150 has an output end 151 communicated with the gas inlets 121 configured for blowing a gas into the gas channels 120. The switch elements 130 each includes a slidable portion 131 having an end surface 133 and a driving portion 132 configured for driving the slidable portion 131.

The mold core 100 is made from a material selected from the group comprising stainless steel, super-hard alloy, carbide ceramic and cermet. The molding surface 110 may be a spherical surface or an aspheric surface. The gas outlets 122 can be arranged around the molding surface 110 in a predetermined layout. The slidable portion 131 is made from a material selected from the group comprising stainless steel, super-hard alloy, carbide ceramic and cermet. The driving portion 132 can be selected from the group comprising spring, screw rod, retractable pole and folding bracket. In the preferred embodiment, the mold core 100 and slidable portions 131 are made from stainless steel. The molding surface 110 is an aspheric surface. The gas outlets 122 are spacedly distributed in an annular region (not labeled) around an edge of the molding surface 110 symmetrically. The annular region has a width of 0.5 mm (millimeter). The diameter of each gas outlet 122 is less than 0.5 mm. The driving portions 132 each employs a folding bracket.

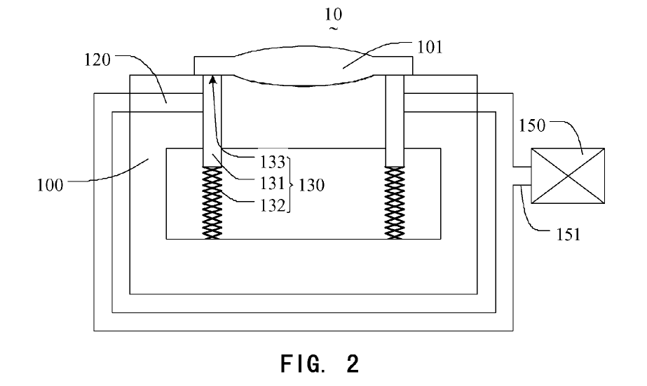

Referring to FIG. 2, the mold 10 is in process for molding an optical element 101. The driving portions 132 are extended and thereby the gas outlets 122 are closed by the slidable portions 131. In the preferred embodiment, the end surfaces 133 of the slidable portions 131 are substantially coplanar with top portion of the molding surface 110. Therefore, portions of the gas channels 120 which adjacent to the gas outlets 122 are plugged by the slidable portions 131.

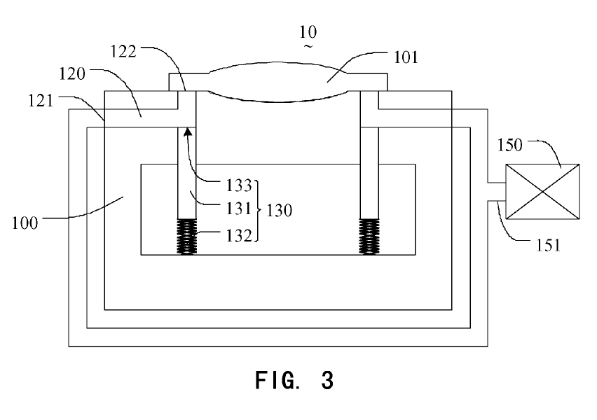

Referring to FIG. 3, a mold releasing method using the mold 10 is also provided. The method comprises the steps of: opening the gas outlets 122 via retracting the slidable portions 131 by the driving portions 132, and the gas outlets 122 and the gas inlets 121 are communicated via the gas channels 120; blowing the gas into the gas channels 120 via the output end 151 and the gas inlets 121 by operating the gas blowing device 150, the gas thereby blowing to a periphery of the optical element 101 via the gas outlets 122; and adjusting the pressure of the gas via controlling the output end 151 thereby pushing the periphery of the optical element 101 to separate the optical element 101 from the molding surface 110. The gas may employ any suitable gas such as nitrogen gas or clean dry air.

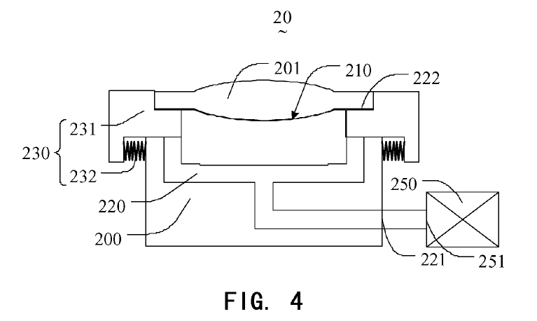

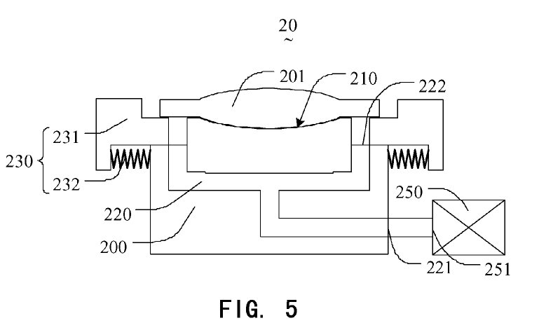

Referring to FIG. 4 and FIG. 5, a mold 20 according to a second preferred embodiment is provided. The mold 20 for molding an optical element 201 includes a mold core 200 and a gas blowing device 250. The mold core 200 includes a molding surface 210, a gas inlets 221, a plurality of gas outlets 222 located around the molding surface 210, a plurality of gas channels 220 connecting the gas inlet 221 and the gas outlets 222, and a plurality of switch elements 230 configured around the molding surface 210 to open and close the gas outlets 222. The gas blowing device 250 has an output end 251 communicated with the gas inlet 221 configured for blowing a gas into the gas channels 220. The switch elements 230 each includes a slidable portion 231 and a driving portion 232 configured for driving the slidable portion 231.

The mold 20 is similar to the mold 10 of the first embodiment. However, the mold 20 only employs one gas inlet 221 connecting with the gas outlets 222 via the gas channels 220. The driving portions 232 are retracted and thereby the gas outlets 222 are closed by the slidable portions 231. The slidable portions 231 are moving at a surface which substantially coplanar with the gas outlets 222.

As stated above, the mold and mold releasing method in accordance with preferred embodiments employ a plurality of gas channels, gas outlets and switch elements. Therefore, during mold releasing processes, the optical element can be separated from the molding surface by gas flow output from the gas outlets. The optical element can be released easily. Furthermore, the movements of the mode core for mold releasing are not necessary, problems such as abrasion and decentration thereby can be avoided.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A mold comprising:
a mold core, the mold core comprising:
a molding surface,
at least one gas inlet,
a plurality of gas outlets located around the molding surface,
a plurality of gas channels defined therein for connecting the at least one gas inlet and the gas outlets, and
a plurality of switch elements positioned around the molding surface and configured for relatively opening and closing the gas outlets; and
a gas blowing device, the gas blowing device comprising an output end communicated with the at least one gas inlet and being configured for blowing gas into the gas channels.

2. The mold in accordance with claim 1, wherein the mold core is made from a material selected from the group consisting stainless steel, super-hard alloy, carbide ceramic and cermet.

3. The mold in accordance with claim 1, wherein the molding surface is selected from a spherical surface and an aspheric surface.

4. The mold in accordance with claim 1, wherein the gas outlets are distributed symmetrically about a center of the molding surface.

5. The mold in accordance with claim 1, wherein the gas outlets are distributed in a 0.5 mm wide annular region around an edge of the molding surface.

6. The mold in accordance with claim 1, wherein the diameter of each gas outlets is less than 0.5 mm.

7. The mold in accordance with claim 1, wherein the switch elements each comprises a slidable portion and a driving portion configured for driving the slidable portion.

8. The mold in accordance with claim 7, wherein the slidable portion is made from a material selected from the group consisting of stainless steel, super-hard alloy, carbide ceramic and cermet.

9. The mold in accordance with claim 7, wherein the driving portion is selected from the group comprising spring, screw rod, retractable pole and folding bracket.

10. The mold in accordance with claim 1, wherein the gas is selected from nitrogen gas and clean dry air.

11. A mold releasing method employing the mold of claim 1, comprising the steps of:
opening the gas outlets by operating the switch elements;
blowing gas into the gas channels via the output end and the at least one gas inlet by operating the gas blowing device; and
ejecting the optical element by adjusting the pressure of the gas via controlling the output end.

12. The method in accordance with claim 11, wherein the switch elements each comprises a slidable portion and a driving portion configured for driving the slidable portion.

13. The method in accordance with claim 12, wherein the slidable portion is made from a material selected from the group consisting of stainless steel, super-hard alloy, carbide ceramic and cermet.

14. The method in accordance with claim 12, wherein the driving portion is selected from the group comprising spring, screw rod, retractable pole and folding bracket.

15. The method in accordance with claim 11, wherein the gas is selected from nitrogen gas and clean dry air.

16. A mold for molding an optical element, comprising:
a mold core with a molding surface configured for supporting a workpiece thereon;
a plurality of gas outlets located around a periphery of the molding surface;
at least one gas inlet configured for connecting with a gas blowing device;
a plurality of gas channels connecting the at least one gas inlet and the gas outlets; and
a plurality of switch elements positioned around the molding surface and configured for selectively opening and closing the gas outlets respectively.

17. The mold in accordance with claim 16, wherein the gas outlets communicate with the periphery of the molding surface.
